(19) United States
(12) Patent Application Publication
(10) Pub. No.: US 2015/0233357 A1
(43) Pub. Date: Aug. 20, 2015

(54) BEDPLATE OF A WIND TURBINE

(71) Applicant: SIEMENS AKTIENGESELLSCHAFT, 80333 MÜNCHEN (DE)

(72) Inventors: Peter Libergren, Galten (DK); Soeren Oemann Lind, Naestved (DK)

(21) Appl. No.: 14/232,299

(22) PCT Filed: Nov. 16, 2012
(86) PCT No.: PCT/EP2012/072882

§ 371 Date: Jan. 13, 2014

(30) Foreign Application Priority Data
Dec. 6, 2011 (EP) 11192186.2

(51) Int. Cl. F03D 11/04; F03D 11/00

(52) U.S. Cl. CPC F03D 11/04; F03D 11/0075

(57) ABSTRACT

The invention relates to a bedplate of a wind turbine comprising or made of a fiber-reinforced composite material.

### CROSS-REFERENCE TO RELATED APPLICATIONS

This application claims priority to PCT Application No. PCT/EP2012/072882, having a filing date of Nov. 16, 2012, the entire contents of which are hereby incorporated by reference.

### FIELD OF TECHNOLOGY

The following relates to a bedplate of a wind turbine.

### BACKGROUND

In normal operation, the wind will generate loads on the rotor of the wind turbine. A major part of these loads will be transferred through various drive train components and through the bedplate to the wind turbine tower. The bedplate may be regarded as being a transition piece connecting the main bearing(s) towards the rotor at one side, and the yaw bearing towards the tower on the other side. However, the bedplate may take different basic shapes dependent on which wind turbine technology is used.

EP 2136074 A illustrates one type of bedplate for the conventional wind turbine construction with a drive train comprising a main shaft and a gearbox. U.S. Pat. No. 7,431,567 B illustrates one type of bedplate for a direct drive wind turbine construction without a main shaft and gear box. It is known to manufacture the bedplate in solid metal, usually in welded steel or cast iron. These types of constructions can be made in large numbers, but have the disadvantage that they offer only moderate structural properties compared to the weight.

### SUMMARY

A first aspect relates to a bedplate which is more stable and lighter than known bedplates and to provide a wind turbine with the same advantages. The bedplate of a wind turbine comprises fiber-reinforced composite material. For example, the bedplate is made of fiber-reinforced composite material. A bedplate comprising or made of composite material is not known from prior art.

The invention is advantageous in that constructing a bedplate using these new materials makes it possible to manufacture a bedplate which is as strong as known from prior art, but is lighter i.e. strength pr. “weight unit” is higher than conventional. The invention is furthermore advantageous in that as the conventional bedplate constitute a large part of the total weight of a wind turbine nacelle construction, transportation, crane operation and tower costs can all be reduced due to the lower weight of the bedplate, and thereby the nacelle.

Further advantages include that the composite bedplate can be casted in a mold using well known and tested casting methods. In other words, the components comprise fiber-reinforced composite material or are made of or consist of fiber-reinforced composite material. Generally, the composite materials are made of two or more constituent materials such as a reinforcement fiber and a resin matrix. The fiber-reinforced composite materials can be configured in 3 ways i.e. continuous, discontinuous or discontinuous, random-oriented fiber-reinforced composite. By the term continuous aligned fiber is meant that the individual fibers are arranged in such a manner that they lay relative close and that adjacent fibers to a large extent overlap in a lengthwise direction in the composite. In contrast hereto, discontinuous aligned fibers are arranged so that to a large extent they do overlap.

The fibers of at least part of or a part of the reinforced material of the bedplate may be configured as continuous fiber reinforced material. Moreover, the fibers of at least part of or a part of the reinforced material may be configured as discontinuous aligned fiber reinforced material. Furthermore, the fibers of at least part of or a part of the reinforced material can be configured as discontinuous random oriented fiber reinforced material.

In one embodiment, the reinforcement fibers are embedded in the composite material. Moreover, the reinforcement can comprise reinforcement bars, for instance such as made of steel, plastics, carbon, glass-fiber etc. The material of the fibers can be at least one of steel, carbon, glass, Kevlar, basalt or any combination thereof. The composite material may comprise a resin matrix. The composite material can comprise a matrix and the material of the matrix comprises or is at least one of concrete, epoxy, polyester, vinylester, iron, steel or any combination thereof. The concrete may be pre-stressed concrete.

Moreover, the bed plate can at least partly be provided with a coating at the outside of the bedplate. Such a coating improves the resistance of the bedplate against environmental influences. The bed plate can be a transition piece for connecting a main bearing towards a rotor at one side, and/or a yaw bearing towards a tower on the other side. For example, the bed plate is a transition piece connecting a main bearing towards a rotor at one side, and/or a yaw bearing towards a tower on the other side. The angle between a first area of the bedplate connecting the main bearing(s) towards the rotor and a second area of the transition piece connecting the yaw bearing towards the tower may be in an angle in a range between 70 to 90 deg., for example such as in the range of 75 to 85 deg., or 82 deg.

Advantageously, the bed plate is hollow so as to allow the passage of a human being.

The fiber-reinforced composite material can comprise fiber rovings. For example, the fibers of the reinforced composite can be at least partly laid out as fiber rovings. Moreover, the fiber-reinforced composite material can comprise a layered or laminated structure. For various embodiments, the continuous reinforced materials may constitute a layered or laminated structure.

The wind turbine comprises a bed plate as previously described. The wind turbine has the same advantages as the described bedplate. The wind turbine may comprise a main bearing, a rotor, a yaw bearing and a tower. The bed plate may be a transition piece connecting the main bearing towards the rotor at one side, and/or the yaw bearing towards the tower on the other side.

### BRIEF DESCRIPTION

Further features, properties and advantages of the present invention will become clear from the following description of embodiments in conjunction with the accompanying drawings, wherein:

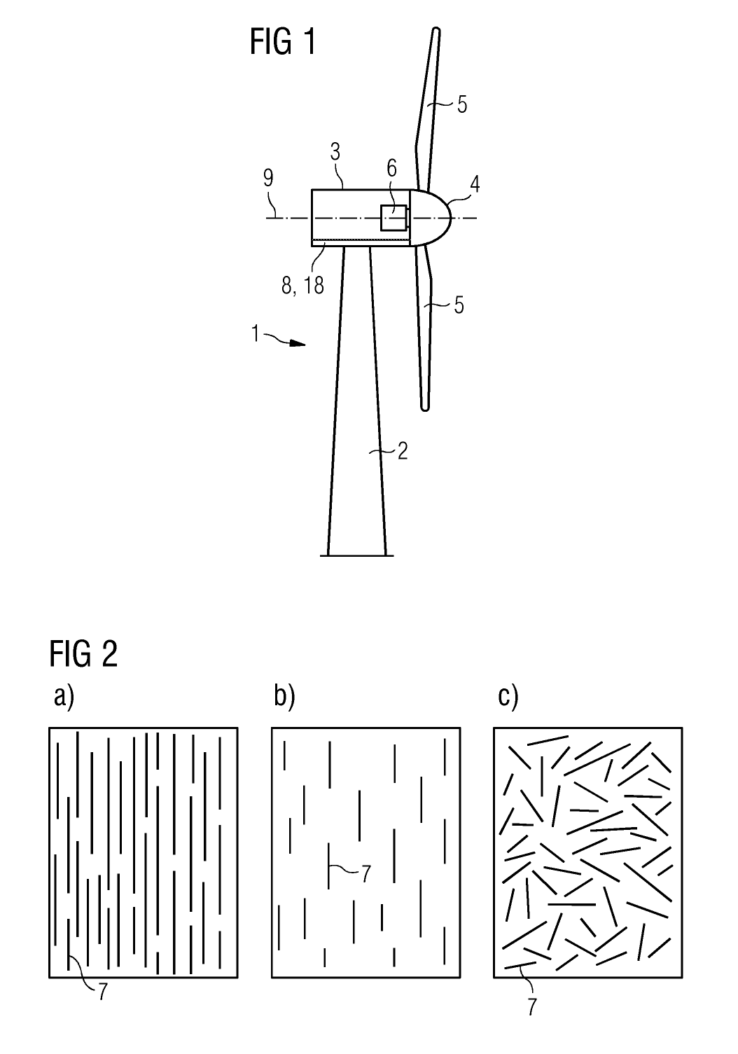

FIG. 1 schematically shows a an embodiment of a wind turbine;

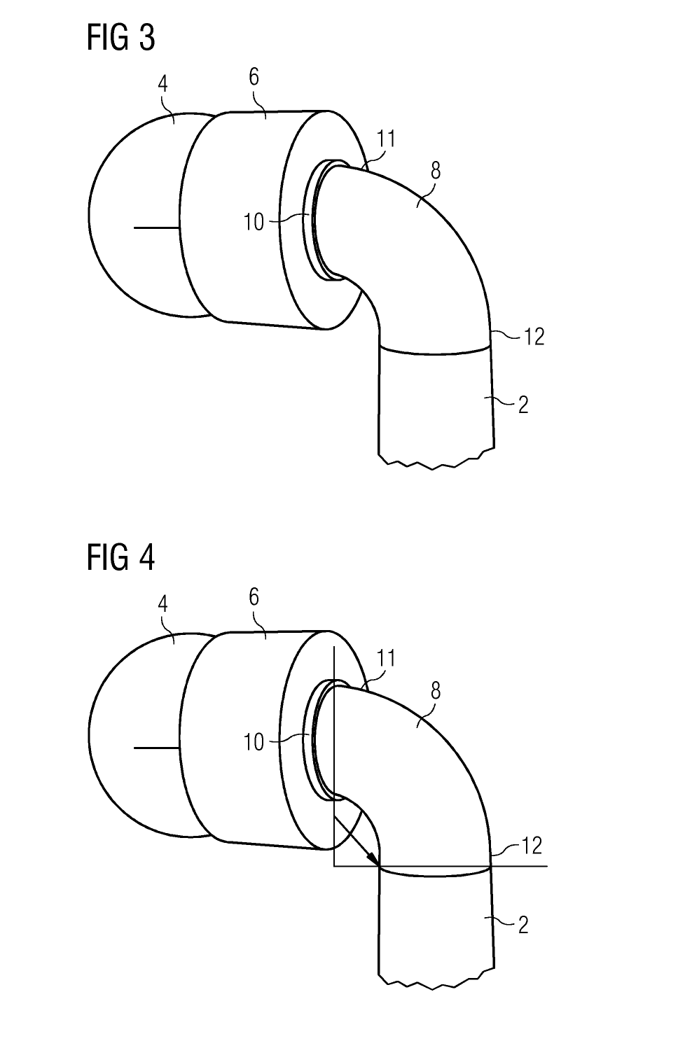

FIG. 2 schematically shows an embodiment of a fiber-reinforced composite material being configured in 3 ways;

FIG. 3 schematically shows an embodiment of a bedplate for a direct drive wind turbine construction and part of the wind turbine;

FIG. 4 schematically shows an embodiment of a bedplate for a direct drive wind turbine construction and part of the wind turbine, as shown in FIG. 3; and

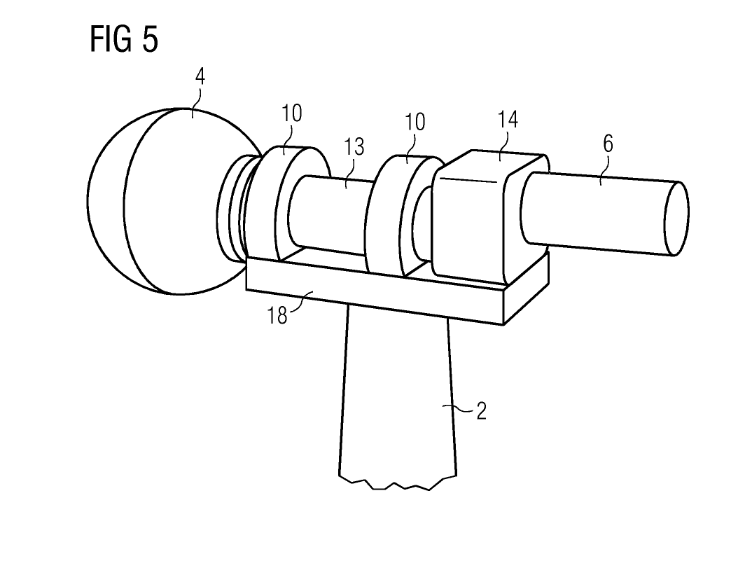

FIG. 5 schematically shows an embodiment of a bedplate for a geared wind turbine construction and part of the wind turbine.

The embodiments do not limit the scope of the present invention which is determined by the appended claims. All described features are advantageous as separate features or in any combination with each other. Corresponding elements of different figures are designated with the same reference numeral and are not repeatedly described.

### DETAILED DESCRIPTION

FIG. 1 schematically shows a wind turbine 1. The wind turbine 1 comprises a tower 2, a nacelle 3 and a hub 4. The nacelle 3 is located on top of the tower 2. The hub 4 comprises a number of wind turbine blades 5. The hub 4 is mounted to the nacelle 3. Moreover, the hub 4 is pivot-mounted such that it is able to rotate about a rotation axis 9. A generator 6 is located inside the nacelle 3. The wind turbine 1 is a direct drive wind turbine or a geared wind turbine. The bedplate is indicated by reference numerals 8 and 18. New materials, such as fiber-reinforced composite materials are used for the construction of the bedplate 8, 18.

FIG. 2 schematically shows fiber-reinforced composite material being configured in 3 ways i.e., continuous, aligned fiber-reinforced composite as shown in FIG. 2(a), discontinuous, aligned fiber-reinforced composite as shown in FIG. 2(b) or discontinuous, random-oriented fiber-reinforced composite as shown in FIG. 2(c). The fibers are designated by reference numeral 7.

As previously mentioned, by the term continuous aligned fiber is meant that the individual fibers 7 are arranged in such a manner that they lay relative close and that adjacent fibers 7 to a large extent overlap in lengthwise direction in the composite. In FIG. 2(a) the individual fibers are oriented parallel or nearly parallel to each other. In contrast, discontinuous aligned fibers are arranged so that they to a large extent overlap. This is schematically shown in FIG. 2(b), wherein the individual fibers 7 are oriented parallel or nearly parallel to each other.

FIG. 2(c) schematically shows random-oriented fiber-reinforced composite, wherein the individual fibers 7 are randomly oriented to each other. The individual fibers 7 include random angles with each other. Some of the individual fibers 7 do overlap. The composite materials are made of two or more constituent materials such as a reinforcement fiber and a resin matrix. Suitable types of fibers may be steel, carbon, glass, kevlar® (aramide fiber) or basalt. Other types of fibers suitable for making composite materials are however also included. Suitable types of resin matrix may be concrete, epoxy, polyester, vinyl ester, iron, steel etc.

Two types of bedplate are schematically illustrated in FIGS. 3, 4 and 5. FIGS. 3 and 4 schematically show a bedplate for a direct drive wind turbine construction and part of the wind turbine. FIG. 5 schematically shows a bedplate for a geared wind turbine construction and part of the wind turbine.

In a first embodiment, the fibers of at least a part of the reinforced material are configured as continuous fiber reinforced material. This is advantageous in that the fibers can be directed or extended in the directions where tension forces occur in the casted bedplate structure. In turn, this ensures that material can be saved as material in areas where there are low tension forces can be reduced.

In a second embodiment, the fibers of at least a part of the reinforced material are configured as discontinuous aligned fiber reinforced material.

In a third embodiment, the fibers of at least a part of the reinforced material are configured as discontinuous random oriented fiber reinforced material. This is advantageous in that the composite material has enhanced strengthening properties in substantially all directions, and thereby no special attention has to be put on how and where to orient the fibers.

In one embodiment, the reinforcement fibers are embedded in the composite material. This is advantageous in that it makes a very strong composite material.

In one embodiment, the reinforcement comprises reinforcement bars such as made of steel, plastics, carbon, glass-fiber etc. Hereby it is possible to reinforce the casted structure in load carrying directions. Even further such bars are easy to handle and does not require special attention on avoiding wrinkles etc. due to uneven lay up of fibers.

In one embodiment, the material of the fibers is at least one of steel, carbon, glass, Kevlar, basalt or any combination thereof. This is advantageous in that each of these products has suitable characteristic properties for being integrated into the composite material of a wind turbine bed plate.

In one embodiment, the composite material comprises a resin matrix. In one embodiment, the material of the matrix is at least one of concrete, epoxy, polyester, vinyl ester, iron, steel or any combination thereof. This is advantageous in that, in combination with the fibers, a very strong bedplate composite construction can be made. In one embodiment, the concrete is pre-stressed concrete. This is advantageous in that it is a special casted structure with enhanced mechanical properties.

In one embodiment, the bed plate further is at least partly provided with a coating at the outside of the bed plate. This is advantageous in that the bed plate thereby can be protected against environmental influences, such as water, salt-water, grease from bearings, oil, humid air etc.

In the example shown in FIGS. 3 and 4, the hub 4 is directly connected to the generator 6. The bedplate 8 is a transition piece connecting the main bearing(s) 10 towards the rotor at one side, and the yaw bearing towards the tower 2 on the other side. Hereby it is ensured that the components of the wind turbine 1 is carried properly and is kept in position sufficiently. The bed plate 8, which has not the shape of a plate, comprises a first portion or area 11 and a second portion or area 12. In one embodiment, the angle between the first area 11 of the bedplate 8 connecting the main bearing(s) 10 towards the rotor and the second area 12 of the transition piece connecting the yaw bearing towards the tower 2 is in an angle in a range between 70 to 90 deg., such as in the range of 75 to 85 deg., or 82 deg. This is schematically illustrated on the FIG. 4, where the vertical line indicates the end surface of said first area 11, the horizontal line indicates the end surface of the second area 12 and the arrow-line 15 indicates the angle between the areas 11 and 12.

In the example shown in FIG. 5, the bedplate 18 has the shape of a plate. It is connected to the tower 2. The generator 6, a gearbox 14, a main shaft 13 and main bearings 10 are placed onto the bedplate 18. The hub 4 is connected to the main shaft 13 by means of a first main bearing 10. The main shaft 13 is connected to the gearbox 14 by means of a second main bearing 10. The generator 6 is connected to the gearbox 14. In FIG. 5, the generator 6 protrudes the bedplate 18.

In one embodiment, the bedplate 8, 18 is hollow so as to allow the passage of a human being. Thereby it is ensured e.g. that service technicians can pass through the invented bedplate 8, 18 so as to allow passage e.g. from the inner of the bedplate 8, 18 to the outer of the bedplate 8, 18, from one side of the bedplate 8, 18 to the other side of the bedplate etc.

Embodiments also relate to a wind turbine comprising the invented bedplate. In one embodiment, the fibers of the reinforced composite are at least partly laid out as fiber rovings. For various embodiments, the continuous reinforced materials may constitute a layered or laminated structure.

1. An apparatus comprising:
a bedplate comprised of fiber-reinforced composite material.

2. The apparatus A bedplate according to claim 1, wherein the reinforcement fibers of at least a part of the fiber-reinforced composite material are configured as at least one of a continuous fiber reinforced material, a discontinuous aligned fiber reinforced material, and a discontinuous random oriented fiber reinforced material.

3. The apparatus according to claim 1, wherein the reinforcement fibers are embedded in the fiber-reinforced composite material.

4. The apparatus according to claim 1, wherein the reinforcement comprises reinforcement bars.

5. The apparatus bedplate according to claim 1, wherein a material of the reinforcement fibers are at least one of steel, carbon, glass, Kevlar, basalt, and any combination thereof.

6. The apparatus according to claim 1, wherein the fiber-reinforced composite material comprises a resin matrix.

7. The apparatus according to claim 1, wherein the fiber reinforced composite material comprises a matrix and a material of the matrix comprises at least one of concrete, epoxy, polyester, vinylester, iron, steel, and or any combination thereof.

8. The apparatus according to claim 7, wherein the concrete is pre-stressed concrete.

9. The apparatus according to claim 1, wherein the bedplate is at least partly provided with a coating at an outside of the bedplate.

10. The apparatus according to claim 1, wherein the bedplate is a transition piece for connecting a main bearing towards a rotor at one side, and/or a yaw bearing towards a tower on the other side.

11. The apparatus according to claim 10, wherein an angle between a first area of the bedplate connecting the main bearing towards the rotor and a second area of the transition piece connecting the yaw bearing towards the tower is in a range between 70 to 90 degrees.

12. The apparatus according to claim 1, wherein the bedplate is hollow so as to allow a passage of a human being.

13. The apparatus according to claim 1, wherein the fiber-reinforced composite material comprises fiber rovings and/or a layered or laminated structure.

14. A wind turbine comprising a bedplate according to claim 1.

15. The wind turbine, as claimed in claim 14, wherein the wind turbine comprises a main bearing, a rotor, a yaw bearing and a tower, and wherein the bedplate is a transition piece connecting the main bearing (10) towards the rotor at one side, and/or the yaw bearing towards the tower on the other side.
